(19) United States
(12) Patent Application Publication
(10) Pub. No.: US 2009/0125640 A1
(43) Pub. Date: May 14, 2009

(54) ULTRASMALL PORTABLE COMPUTER APPARATUS AND COMPUTING SYSTEM USING THE SAME

(76) Inventors: John SUNWOO, Daejeon (KR); Baesun KIM, Daejeon (KR); Ilyeon CHO, Daejeon (KR); Hyuntae JEONG, Daejeon (KR); Yongki SON, Daejeon (KR); Dongwon HAN, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/118,862

(22) Filed: May 12, 2008

(30) Foreign Application Priority Data
Nov. 13, 2007 (KR) 10-2007-0115687
May 6, 2008 (KR) 10-2008-0041828

(51) Int. Cl. G06F 3/00

(52) U.S. Cl. 710/3

(57) ABSTRACT

An ultrasmall portable computer apparatus includes a communication unit for communication with peripheral devices, and a storage unit for storing an identification information list of the peripheral devices and at least one program. A control unit compares identification information provided through the communication unit from a peripheral device with the identification information list and executing part or all of the programs according to the comparison result.

### CROSS-REFERENCE(S) TO RELATED APPLICATIONS

The present invention claims priority of Korean Patent Application Nos. 10-2007-0115687, filed on Nov. 13, 2007 and No. 10-2008-0041828, filed on May 6, 2008, which are incorporated herein by reference.

### FIELD OF THE INVENTION

The present invention relates to an ultrasmall portable computer apparatus and a computing system using the same. In particular, the present invention relates to an ultrasmall computer apparatus adapted to have minimum computing resources, thereby achieving ease of portability, and an ultrasmall portable computing system including an input/output device for the computer apparatus.

This work was supported by the IT R&D program of MIC/IITA [2005-S-065-03, Development of Wearable Personal Station].

### BACKGROUND OF THE INVENTION

In recent years, with the development of ubiquitous computing environment and wearable computing environment, many studies have been made to reduce the size of the computer, thereby achieving ease of portability.

Meanwhile, peripheral devices, such as an input/output device and the like, limit the reduction in size of the computer. The peripheral devices which are used to input user's commands and output processing results require minimum installation spaces, such that the reduction in size of the computer is limited.

In the related art, technology for reducing the size of the computer concentrates on the implementation of a single computer apparatus including peripheral devices to provide as many functions as possible. Accordingly, it is difficult to implement an ultrasmall computer having portability enough for a user to carry the computer with him/her anytime and anywhere.

### SUMMARY OF THE INVENTION

It is a primary object of the present invention to provide a computer apparatus having minimum computing resources by independently providing peripheral devices, such as an input/output device and the like, thereby achieving ease of portability.

It is another object of the present invention to provide a computing system including peripheral devices which are in connection with a computer apparatus having minimum computing resources in a wired or wireless manner, thereby providing efficient ubiquitous and wearable computing environment.

In accordance with an aspect of the present invention, there is provided an ultrasmall portable computer apparatus, including:

a communication unit for communication with peripheral devices;

a storage unit for storing an identification information list of the peripheral devices and at least one program;

a control unit for comparing identification information provided through the communication unit from a peripheral device with the identification information list and executing part or all of the programs according to the comparison result.

Moreover, the ultrasmall portable computer apparatus further including a motion sensing unit for collecting at least one motion pattern of the ultrasmall portable computer apparatus acquired by a motion sensor, and generating and storing a motion sensing data list. In addition, the storage unit further stores the motion sensing data list, a processing data list which includes processing data corresponding to the motion patterns of the motion sensing data list, and a program for controlling the output of the processing data, and the control unit executes the program for controlling the output of the processing data according to a comparison result of motion sensing data acquired by the motion sensor and the motions sensing data list.

In accordance with another aspect of the present invention, there is provided an ultrasmall portable computing system, including:

peripheral devices; and

an ultrasmall portable computer apparatus adapted to communicate with the peripheral devices,

wherein the ultrasmall portable computer apparatus includes:

a communication unit for communication with the peripheral devices,

a storage unit for storing an identification information list of the peripheral devices and at least one program, and

a control unit for comparing identification information input through the communication unit from a peripheral device with the identification information list and executing part or all of the programs.

Moreover, the ultrasmall portable computer apparatus further includes a motion sensing unit for collecting at least one motion pattern of the ultrasmall portable computer apparatus acquired by a motion sensor, and generating and storing a motion sensing data list. In addition, the storage unit further stores the motion sensing data list, a processing data list, which includes processing data corresponding to the motion patterns of the motion sensing data list, and a program for controlling the output of the processing data, and the control unit executes the program for controlling the output of the processing data according to a comparison result of motion sensing data acquired by the motion sensor and the motions sensing data list.

### BRIEF DESCRIPTION OF THE DRAWINGS

The above and other objects and features of the present invention will become apparent from the following description of embodiments, given in conjunction with the accompanying drawings, in which:

FIG. 1 is a diagram illustrating the construction of an ultrasmall portable computing system in accordance with a first embodiment of the present invention;

FIG. 2 is a detailed block diagram of a computer apparatus shown in FIG. 1;

FIG. 3 is a detailed block diagram of an input/output interface device shown in FIG. 1;

FIG. 4 is a diagram illustrating the construction of an ultrasmall portable computing system in accordance with a second embodiment of the present invention;

FIG. 5 is a flowchart illustrating a control method for a computer apparatus in accordance with a third embodiment of the present invention; and

FIG. 6 is a flowchart illustrating a control method for a computer apparatus in accordance with a fourth embodiment of the present invention.

### DETAILED DESCRIPTION OF THE INVENTION

Exemplary embodiments of the present invention will now be described with reference to the accompanying drawings. In the following description, detailed description of known structures and functions incorporated herein will be omitted when it may make the subject matter of the invention unclear.

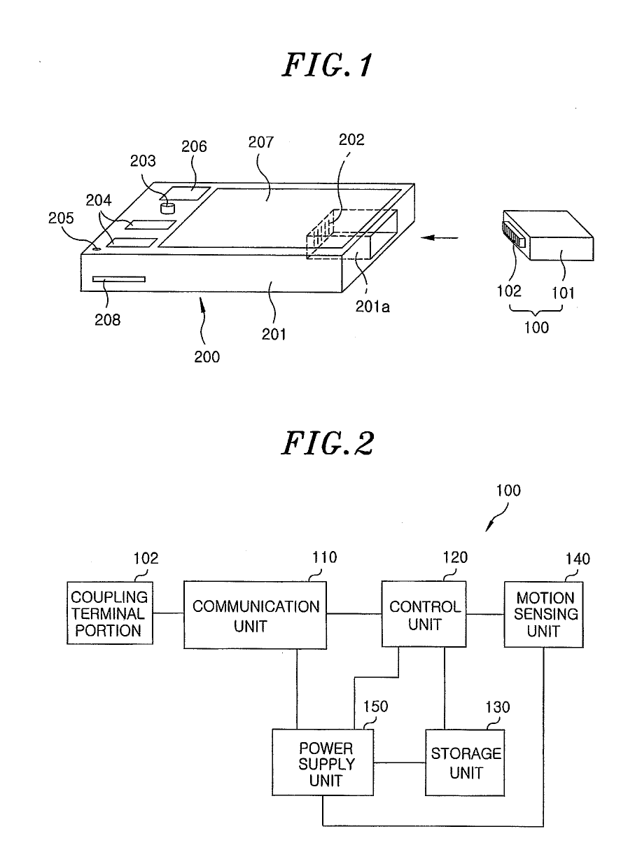

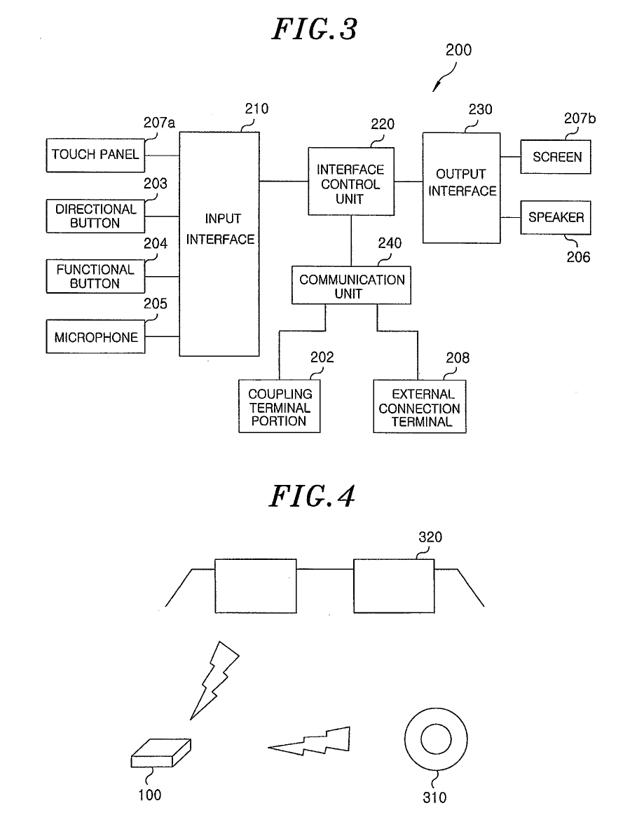

FIG. 1 is a diagram illustrating the construction of an ultrasmall portable computing system according to a first embodiment of the present invention. FIG. 2 is a detailed block diagram of a computer apparatus shown in FIG. 1. FIG. 3 is a detailed block diagram of an input/output interface device shown in FIG. 1.

A computing system according to the first embodiment of the present invention will now be described with reference to FIGS. 1 to 3.

An ultrasmall portable computing system according to the first embodiment of the present invention includes: a computer apparatus 100 having a case 101 with a coupling terminal portion 102 on one side thereof; and an input/output interface device 200 having an insertion space 201a, through which the computer apparatus 100 is inserted to be connected with the input/output interface device 200 as a single body, with a coupling terminal portion 202 for connection with the computer apparatus 100 on the inside of the insertion space 201a. The computer apparatus 100 and the input/output interface device 200 are electrically connected with each other through the coupling terminal portions 102 and 202. For example, the input/output interface device 200 may be implemented with a PMP (Portable Multimedia Player) expansion module.

The computer apparatus 100 stores an identification information list including identification information of connectable peripheral devices, such as the input/output interface device 200 and the like. Then, the computer apparatus 100 communicates a peripheral device, compares identification information transmitted from the peripheral device according to the communication result with the stored identification information, and executes part or all of at least one program according to the comparison result. In addition, the computer apparatus 100 collects at least one motion pattern acquired by a motion sensor, and generates and stores a list for motion sensing data. Then, the computer apparatus 100 compares the motion sensing data acquired by the motion sensor in real time with the motion sensing data list, and executes part or all of at least one program according to the comparison result.

The detailed construction of the computer apparatus 100 will now be described. The computer apparatus 100 includes a communication unit 110, a control unit 120, a storage unit 130, a motion sensing unit 140, and a power supply unit 150.

The communication unit 110 communicates with the external input/output interface device 200 assigned with identification information and receives the identification information therefrom.

The storage unit 130 stores therein status reference data corresponding to the environment of the computer apparatus 100 in use. For example, the storage unit 130 stores, as the status reference data, the identification information list of the connectable peripheral devices, such as the input/output interface device 200 and the like. In addition, the storage unit 130 stores, as the status reference data, a motion sensing data list generated on the basis of motion patterns acquired by the motion sensing unit 140. Moreover, the storage unit 130 stores a processing data list including processing data corresponding to the motion patterns of the motion sensing data list, and a plurality of programs which can be selectively executed by the control unit 120.

The motion sensing unit 140 senses the motion of the computer apparatus 100 and transmits motion sensing data to the control unit 120. For example, the motion sensing unit 140 may be implemented with a motion sensor (for example, a three-axis acceleration sensor).

The control unit 120 compares identification information of a peripheral device provided through the communication unit 110 with the identification information list as the status reference data stored in the storage unit 130, or compares the motion sensing data provided through the motion sensing unit 140 with the motion sensing data list as the status reference data stored in the storage unit 130, and executes part or all of the programs stored in the storage unit 130 according to the comparison result. In addition, the control unit 120 extracts, from the storage unit 130, processing data corresponding to the motion sensing data according to the comparison result, and executes a corresponding output control program in the storage unit 130 such that the processing data is output to the peripheral devices, such as the input/output interface device 200 and the like. Moreover, when it is determined that it is not necessary to drive motion sensing unit 140 according to the comparison result of the identification information of the peripheral device input through the communication unit 110 and the identification information list as the status reference data stored in the storage unit 130, the control unit 120 may shut off driving power supply from the power supply unit 150 to the motion sensing unit 140 to inactivate the motion sensing unit 140.

The power supply unit 150 supplies the driving power to the communication unit 110, the control unit 120, the storage unit 130, and the motion sensing unit 140.

The input/output interface device 200 is connected to the computer apparatus 100 through the coupling terminal portion 202 to function as a peripheral device, and communicates with the computer apparatus 100 through the coupling terminal portion 202. That is, the input/output interface device 200 transmits assigned identification information to the computer apparatus 100, such that the computer apparatus 100 recognizes the corresponding peripheral device on the basis of the identification information. In addition, the input/output interface device 200 transmits a signal input by means of an input device to the computer apparatus 100 through the coupling terminal portion 202, and when receiving a signal from the computer apparatus 100 through the coupling terminal portion 202, outputs the signal to the outside through an output device. The input/output interface device 200 is supplied with the driving power from the power supply unit 150 of the computer apparatus 100 through the coupling terminal portion 202.

The detailed construction of the input/output interface device 200 will now be described. The input/output interface device 200 includes input devices, such as a direction button 203, a functional button 204, a microphone 205, and a touch panel 207a, and output devices, such as a speaker 206 and a screen 207b. The input/output interface device 200 further includes an input interface 210, an interface control unit 220, an output interface 230, a communication unit 240, and an external connection terminal 208. Here, the touch panel 207a and the screen 207b are integrated as a single body to form a touch screen 207.

The input devices, such as the directional button 203, the functional button 204, the microphone 205, and the touch panel 207a, are exposed outward of the case 201. Further, the input devices provide signals to the computer apparatus 100 through the coupling terminal portion 202.

The output devices, such as the speaker 206 and the screen 207b, are exposed outward of the case 201. Further, the output devices receive signals from the computer apparatus 100 through the coupling terminal portion 202 and output the received signals to the outside.

The communication unit 240 is provided in the case 201 and communicates with the computer apparatus 100 through the coupling terminal portion 202.

The interface control unit 220 is provided in the case 201, and transmits assigned identification information to the computer apparatus 100 through the communication unit 240 and the coupling terminal portion, such that the computer apparatus 100 recognizes the peripheral device on the basis of the identification information.

The input interface 210 is provided in the case 201 and connects the input devices, such as the directional button 203, the functional button 204, the microphone 205, and the touch panel 207a, with the interface control unit 220.

The output interface 230 is provided in the case 201 and connects the output devices, such as the speaker 206 and the screen 207b, with the interface control unit 220.

The external connection terminal 208 through which an external electronic devices is connected is exposed outward of the case 201. In addition, in a state where the electronic apparatus is connected through the external connection terminal 208, the communication unit 240 communicates with the electronic apparatus through the external connection terminal 208.

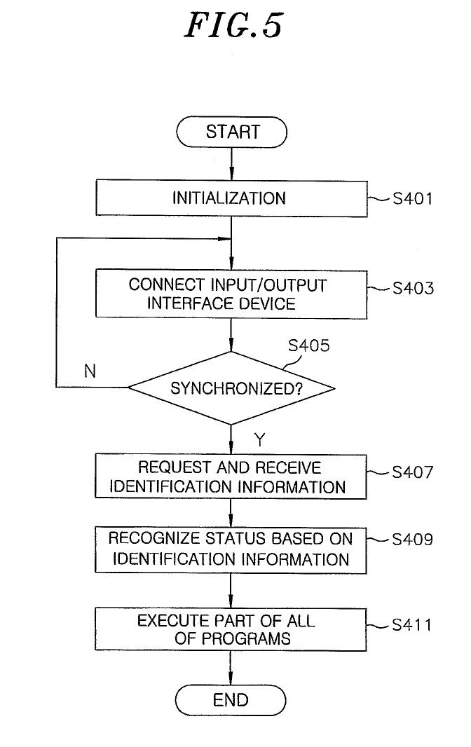

FIG. 4 is a diagram illustrating the construction of an ultrasmall portable computing system according to a second embodiment of the present invention.

Referring to FIG. 4 an ultrasmall portable computing system includes a computer apparatus 100, a gesture recognition device 310, and an HMD (Head Mounted Display) 320.

The gesture recognition device 310 is an example of an input interface device according to the present invention. The gesture recognition device 310 is in a wearable shape such that a user can easily put it on his/her body, such as a wrist or a finger. The gesture recognition device 310 recognizes a gesture by the user, such as hand movement, and transmits a gesture recognition signal in a wireless manner. In particular, according to the present invention, the gesture recognition device 310 is assigned with intrinsic identification information. Then, after being synchronized for connection with the computer apparatus 100, the gesture recognition device 310 transmits the identification information in a wireless manner, such that the computer apparatus 100 can recognize the connection state with the gesture recognition device 310. Such gesture recognition device 310 includes a gesture recognition band well known in the art, and thus the detailed description thereof will be omitted.

As described above with reference to FIG. 2, the computer apparatus 100 includes the communication unit 110, the control unit 120, the storage unit 130, the motion sensing unit 140, and the power supply unit 150. Here, since the computer apparatus 100 and the gesture recognition device 310 are connected with each other in a wireless manner, the coupling terminal portion 102 may be removed.

The HMD 320 is an example of an output interface device according to the present invention. According to the present invention, the HMD 320 is assigned with intrinsic identification information. Then, after being synchronized for connection with the computer apparatus 100, the HMD 320 transmits the identification information in a wireless manner, such that the computer apparatus 100 can recognize the connection state with the HMD 320. The HMD 320 may be in a shape of glasses or helmet well known in the art, and thus the detailed description thereof will be omitted.

FIG. 4 illustrates an example where the computer apparatus 100 according to the present invention may be connected to various peripheral devices. In addition, the computer apparatus 100 may be connected to various peripheral devices, such as an in-vehicle display, a mobile navigation device, a personal display, a digital camera, a portable recorder, and a portable communication terminal.

FIG. 5 is a flowchart illustrating a control method for an ultrasmall portable computer apparatus according to a third embodiment of the present invention.

The operation of the computer apparatus according to the present invention will be described with reference to FIG. 5. In this connection, a case in which the computer apparatus 100 shown in FIG. 2 and the input/output interface device 200 shown in FIG. 3 are connected with each other through the coupling terminal portions 102 and 202 is taken into consideration.

First, in an initialization state at step S401, the computer apparatus 100 stores, in the storage unit 130, an identification information list including identification information assigned to the input/output interface device 200 and other peripheral devices.

When the computer apparatus 100 is connected with the input/output interface device 200 through the coupling terminal portions 102 and 202 at step S403, the computer apparatus 100 and the input/output interface device 200 perform communication through the communication units 110 and 240, and are synchronized for inter-connection at step S405.

At step S407, the control unit 120 of the computer apparatus 100 requests the interface control unit 220 of the input/output interface device 200 to transmit the identification information, and if the interface control unit 220 transmits the identification information according to the request to transmit the identification information, receives the identification information.

At step S409, when receiving the identification information from the input/output interface device 200, the control unit 120 of the computer apparatus 100 compares the received identification information with the identification information list as the status reference data stored in the storage unit 130, extracts corresponding identification information from the identification information list, and performs a status recognition processing to determine whether or not a currently connected peripheral device is the input/output interface device 200.

At step S411, if the status recognition processing is completed, the control unit 120 of the computer apparatus 100 executes part or all of the programs stored in the storage unit 130 according to the status recognition result. That is, the control unit 120 selectively executes application programs required for connection with the input/output interface device 200 among a plurality of programs stored in the storage unit 130, while not performing unnecessary application programs. In addition, if it is determined that it is not necessary to provide the motion sensing unit 140 for connection with the input/output interface device 200, the control unit 120 inactivates the motion sensing unit 140 by shutting off power supply to the motion sensing unit 140 from the power supply unit 150.

As such, according to the control method of the present invention, when being connected with a peripheral device, the computer apparatus 100 dynamically and automatically executes a program or assigns a memory according to the purpose of the function of the peripheral device, and inactivates unnecessary hardware or software components, thereby achieving low power consumption and improving use efficiency. For example, even if the computer apparatus has a navigation function and a multimedia function by software, when it is connected with a car stereo system or a desktop monitor serving as a peripheral device, an unnecessary navigation function or multimedia function may be automatically inactivated, and a business function, such as a messenger function or a recording function may be automatically activated.

Furthermore, in a state where the computer apparatus 100 and the input/output interface device 200 are connected with each other through communication, the user's command is input through the input/output interface device 200, the control unit 120 may recognize the user's command through the communication unit 110 and execute part or all of the programs according to the corresponding input, similarly to the above-described status recognition processing.

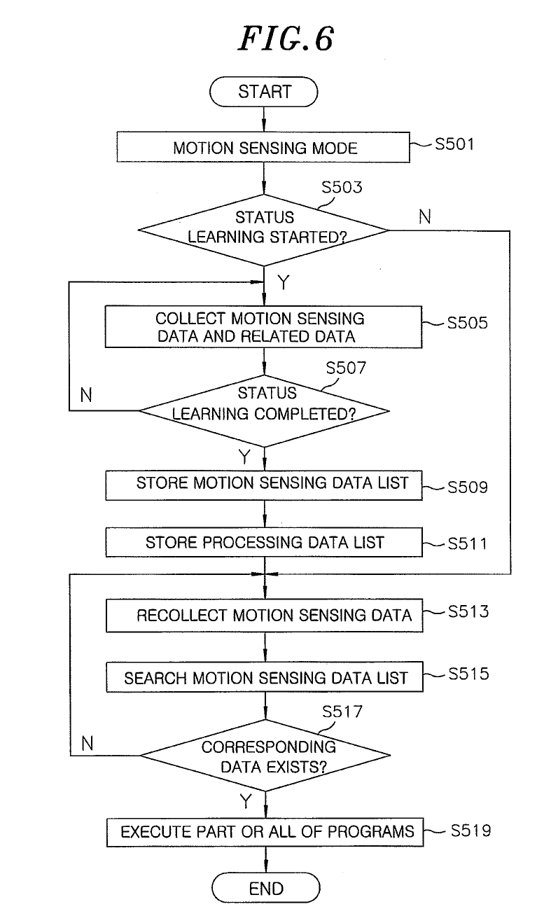

FIG. 6 is a flowchart illustrating a control method for an ultrasmall portable computer apparatus according to a fourth embodiment of the present invention.

The operation of the computer apparatus according to the present invention will be described with reference to FIG. 6. Here, a case in which the computer apparatus 100 shown in FIG. 2 and a portable communication terminal serving as an input/output interface device are connected with each other through wireless communication (for example, Bluetooth, ZigBee) is taken into consideration.

First, at step S501, if a predetermined button is operated, the control unit 120 of the computer apparatus 100 enters a motion sensing mode.

After a button of a portable communication terminal to input a status learning start command is operated, the control unit 120 collects motion sensing data from the motion sensing unit 140 until a button to input a status learning end command is operated. Also, the control unit 120 collects data related to a program (or processor) to be executed in correspondence with motion sensing data acquired by the portable communication terminal, that is, processing data (for example, an automatic transfer message), at steps S503 to S507.

Next, at step S509, the control unit 120 generates status reference data on the basis of the acquired motion sensing data and the processing data, and stores the generated status reference data in the storage unit 130. The status reference data may be generated several times according to different statuses. In this case, at step S511, a motion sensing data list and a processing data list are stored in the storage unit 130.

As such, in a state where the status reference data is stored in the storage unit 130, if the motion sensing unit 140 recollects motion sensing data in real time and transmits the recollected motion sensing data to the control unit 120 at step S513, the control unit 120 retrieves the motion sensing data list and then confirms whether or not status reference data including corresponding motion sensing data among the status reference data stored in the storage unit 130 exists at steps S515 and S517.

Next, if it is confirmed, at step S517, that the status reference data corresponding to the recollected motion sensing data is extracted, the control unit 120 automatically executes part or all of the programs stored in the storage unit 130 such that processing data corresponding to the extracted status reference data is output through a peripheral device, such as a portable communication terminal. That is, the control unit 120 executes an output control program to control the output of the extracted processing data among the programs stored in the storage unit 130, and outputs the processing data through the communication unit 110 and the peripheral device at step S519. For example, the control unit 120 executes a corresponding application program to output an automatic transfer message to the portable communication terminal serving as a peripheral device, such that the portable communication terminal performs an automatic message transfer function. Alternatively, the control unit 120 executes an automatic message transfer program to directly perform an automatic message transfer function.

With the control method according to the present invention, motion information for a predetermined time is stored according to a request by a user who carries the computer apparatus 100, learning is made, and when a learned motion pattern is sensed later, a specific service defined by the user is provided. For example, in respects to an incoming call when the user uses a meal service at the cafeteria, a message “I'm not available” may be automatically transmitted.

Meanwhile, in the foregoing embodiment, for ease of understanding of the present invention, the control method for the ultrasmall portable computer apparatus shown in FIG. 5 and the control method for the ultrasmall portable computer apparatus shown in FIG. 6 have been separately described, but the control methods may of course be implemented as a single control method. This can be applied to the ultrasmall portable computing systems shown in FIGS. 1 and 4.

Since the computer apparatus 100 according to the present invention does not have an input/output interface, the user can set such that the computer apparatus may be used with a registered or authorized input interface device, output interface device, or input/output interface device. In this way, an unauthorized person cannot change or read the content of the computer apparatus 100, thereby providing high security.

According to the aspects of the present invention, by independently providing the peripheral devices, such as an input/output device and the like, the computer apparatus is adapted to have minimum computing resources, thereby reducing the size of the computer apparatus and improving portability.

Furthermore, the computer apparatus selectively executes a required program according to a peripheral device connected with the computer apparatus, and thus power consumption can be reduced. In addition, by selectively executing a required program according to a motion sensing result, the computer apparatus can be operated according to the motion, thereby improving convenience to use.

Furthermore, since the input/output device and the like are independently provided, it is not possible for a third person to operate the computer apparatus with no input/output device, thereby improving security.

While the present invention has been described with respect to the exemplary embodiments, it will be apparent to those skilled in the art that various changes and modifications may be made without departing from the scope of the present invention as defined in the following claims.

What is claimed is:

1. An ultrasmall portable computer apparatus, comprising:
a communication unit for communication with peripheral devices;
a storage unit for storing an identification information list of the peripheral devices and at least one program;
a control unit for comparing identification information provided through the communication unit from a peripheral device with the identification information list and executing part or all of the programs according to the comparison result.

2. The ultrasmall portable computer apparatus of claim 1, further comprising:
a motion sensing unit for collecting at least one motion pattern of the ultrasmall portable computer apparatus acquired by a motion sensor, and generating and storing a motion sensing data list,
wherein the storage unit further stores the motion sensing data list, a processing data list which includes processing data corresponding to the motion patterns of the motion sensing data list, and a program for controlling the output of the processing data, and
wherein the control unit executes the program for controlling the output of the processing data according to a comparison result of motion sensing data acquired by the motion sensor and the motions sensing data list.

3. The ultrasmall portable computer apparatus of claim 1, wherein the peripheral device includes at least one of a PMP (Portable Multimedia Player) expansion module, a mobile navigation device, a digital camera, a portable recorder, a portable communication terminal, a gesture recognition band, and an HMD (Head Mounted Display).

4. An ultrasmall portable computing system, comprising:
peripheral devices; and
an ultrasmall portable computer apparatus adapted to communicate with the peripheral devices,
wherein the ultrasmall portable computer apparatus includes:
a communication unit for communication with the peripheral devices,
a storage unit for storing an identification information list of the peripheral devices and at least one program, and
a control unit for comparing identification information input through the communication unit from a peripheral device with the identification information list and executing part or all of the programs.

5. The ultrasmall portable computing system of claim 4, wherein the ultrasmall portable computer apparatus further includes a motion sensing unit for collecting at least one motion pattern of the ultrasmall portable computer apparatus acquired by a motion sensor, and generating and storing a motion sensing data list,
wherein the storage unit further stores the motion sensing data list, a processing data list, which includes processing data corresponding to the motion patterns of the motion sensing data list, and a program for controlling the output of the processing data, and
wherein the control unit executes the program for controlling the output of the processing data according to a comparison result of motion sensing data acquired by the motion sensor and the motions sensing data list.
